(19) United States
(12) Patent Application Publication
(10) Pub. No.: US 2009/0259584 A1
(43) Pub. Date: Oct. 15, 2009

(54) BLOCK TRADING SYSTEM AND METHOD PROVIDING PRICE IMPROVEMENT TO AGGRESSIVE ORDERS

(76) Inventors: Henri Waelbroeck, Scarsdale, NY (US); Fred J. Federspiel, Larchmont, NY (US); Andrew Roper, Brooklyn, NY (US); Howard Engelhart, Hoboken, NJ (US); Sean Kirkpatrick, Chesterfield, NJ (US)

Correspondence Address: BLANK ROME LLP, WATERGATE, 600 NEW HAMPSHIRE AVENUE, N.W., WASHINGTON, DC, 20037, US

(21) Appl. No.: 12/419,867

(22) Filed: Apr. 7, 2009

Related U.S. Application Data
(60) Provisional application No. 61/043,172, filed on Apr. 8, 2008.

(51) Int. Cl. G06Q 40/00

(52) U.S. Cl. 705/37

(57) ABSTRACT

A first market participant submits an order comprising an indication of a level of visibility which the first market participant wishes to accord to notifications associated with the order. The indication of the level of visibility is independent of identities of second market participants. The notifications associated with the order are displayed on the computer systems of the second market participants only in accordance with the indication of the level of visibility.

### REFERENCE TO RELATED APPLICATIONS

The present application claims the benefit of U.S. Provisional Patent Application No. 61/043,172, filed Apr. 8, 2008. Related subject matter is disclosed in U.S. patent application Ser. Nos. 10/310,345, filed Dec. 5, 2002; 10/603,100, filed Jun. 24, 2003; 10/799,205, filed Mar. 11, 2004; 11/783,250 through 11/783,254, all filed Apr. 6, 2007; 12/181,028, filed Jul. 28, 2008; and 12/181,117, filed Jul. 28, 2008, all currently pending. The disclosures of all of those applications are hereby incorporated by reference in their entireties into the present application.

### FIELD OF THE INVENTION

The present application is directed to a system and method for online trading and more particularly to a system and method for online trading which protect prices against aggressive orders.

### DESCRIPTION OF RELATED ART

In public securities markets, market mechanics and trading psychology create barriers to efficient information dissemination and price discovery. A market participant's decision to reveal information about his or her true price limits represents a tradeoff between the market impact cost of affecting price expectations and the opportunity cost of delaying or failing to execute a trade. As used herein, the term “market participant” refers to any person or firm with the ability to trade securities or other financial products; examples of market participants include broker-dealers, institutions, hedge funds, statistical arbitrage and other proprietary trading operations, and private investors trading on electronic communication networks (ECNs).

By displaying a buyer's true price limit to one or more prospective sellers, for example, a market participant is in effect writing an option that either of the sellers may freely elect to execute; as long as this option is open it sets a lower bound on the market participants' expectations of what the fair trade price should be. Even if one of the sellers originally had a lower price expectation, this expectation is immediately changed when the buyer's price limit is known, the only remaining question being whether the fair price should be even higher. Indeed, by disclosing a high price the buyer indicates an eagerness to acquire the stock, which may reflect information that has yet to come to the seller's attention.

Broker-dealers cope with this problem by carefully managing expectations of parties on both sides of a trade until a fair price has been discovered, and then proposing a fair trade price that can be satisfactory to both. Today such agency orders are increasingly delivered electronically. Orders identified as “not held” are not displayed on the public market, to avoid the above-mentioned impact on price expectations. Brokers may receive crossing not held orders on the buy and sell sides, and find themselves in the position of having to choose a fair price to execute the crossed trade, somewhere between the limits of the two orders. Discretion is normally used when handling such a situation. For example, if a buyer has placed a large block buy order at $30.00 at 10:00 AM, and the market has since fallen to a current best offer of $29.80, a large block sell order at $29.99 would most likely not be automatically crossed at this price, since it now seems expensive compared to the current market; the buyer's limit is interpreted as an instruction to stop buying if the market price were to rise above this level. But a block sell order at $29.82, which also crosses the buyer's much higher limit, would probably be accepted, while one at $29.85 might prompt the broker to call the buyer.

This human intermediation comes at a steep price, both in terms of commissions paid and in terms of information leakage to individuals who have close relationships with aggressive trading firms such as hedge funds. This has fueled a desire from large institutions to find an alternate marketplace where they can post their orders themselves, without discretionary intervention by a traditional broker.

Electronic markets such as NASDAQ or Electronic Communication Networks (ECNs) are not well equipped to handle the price discovery problem for large block trades. In its simplest form, an electronic marketplace simply displays the trading interests of the buyers and sellers to their subscribers, which then have the ability to execute such buy and sell interests. To avoid impacting the market participants' price expectations, users of electronic markets typically place relatively small orders at passive prices, and patiently wait for others to execute them, or take a somewhat more aggressive stance and execute the orders that others have posted on the other side of the spread.

Tools are available to “slice and dice” larger orders into a large number of small pieces that can be worked in this manner, but their activity inevitably reveals the existence of the larger order to those who are skilled in the art of statistical analysis. Such traders develop and optimize trading strategies that deliberately detect large confidential orders as they are being worked, and generate profits by anticipating the market impact that those orders are likely to cause. The simplest such strategy is that of taking a position ahead of the larger order and relying on its continued presence to push the price in a profitable direction. By trading in the same direction as the large order, such parasitic strategies end up exacerbating the price movements that would naturally have been caused by the large order in the first place. The end result is not altogether different from that of posting a large order on the New York Stock Exchange: in the latter case, floor traders join in to “participate” with an auctioned order, or directly step in front to intercept the liquidity that it was able to attract. The terms “penny-jumping” and “front-running” have come to be applied to describe this type of parasitic strategy on the NYSE floor and on electronic marketplaces alike.

Some ECNs offer more sophisticated order types in an attempt to alleviate the front-running problem. Some of these (e.g., discretion orders), simply try to mask the true price limit by showing one price but grabbing priority to execute up to a higher confidential price limit. These suffer from simple counter-strategies, such as that of spraying small orders at different price levels to see when an order gets executed at an undisplayed price level. Other sophisticated order types use minimum quantity conditions in conjunction with hidden discretionary prices to avoid detection by sprays of tiny orders. Since no price is displayed there is no “price revelation” in the traditional sense. Yet, a block trader with a contra interest can discover the first order's limit, and would indeed have a fiduciary obligation to do so, simply by repeatedly placing and canceling orders at steadily worse price levels until the order intersects with the resident order's limit. Thus, although price expectations are not altered prior to the trade, a trader who places a large hidden order on an ECN to buy at $30.00 should indeed expect to trade at $30.00, even if the seller would otherwise have been willing to accept any price down to $29.90.

As a result, electronic books such as SuperMontage have difficulty attracting significant size orders at attractive price levels, as most participants quickly learn that it is more profitable to lurk in the shadows and take what prices others are willing to show, or display small sizes at a time. This has led to an evolution of the marketplace wherein the average trade size has fallen steadily to about 500 shares while the total traded volume and average institutional order sizes have been increasing.

In this environment, there is an acute need for an electronic trading system that rewards traders who are willing to confidentially express their true price aggression with the benefit of price improvement when the contra party is similarly aggressive. In such a block trading solution, the optimal strategy for aggressive traders should be to place their orders with an aggressive price, while passive traders would naturally be best served by placing passively priced orders.

Yet answering such a need cannot come at the expense of the main perceived advantage of electronic trading systems over traditional marketplaces, which is the ability to instantly execute trades with no human intermediation or pre-trade information leakage.

The challenge, in short, is to protect an order that is electronically executable at an aggressive limit price from actually being executed at such an aggressive price when the contra was in fact willing to be aggressive as well.

To tip the scale back in favor of the party who has placed an aggressive order, without losing the perceived advantage of electronic-speed executions and without the mediation of a third party, one must identify value items that can strengthen the negotiating position of a party who is willing to express an aggressive price. One such value item is information. Related application Ser. No. 10/603,100, filed Jun. 24, 2003; Ser. No. 09/870,845, filed May 31, 2001; Ser. No. 09/750,768, filed Dec. 29, 2000 and Ser. No. 09/585,049, filed Jun. 1, 2000 (the entire contents of each are incorporated herein by reference) show how parties willing to confidentially disclose Certified Trading Interest information to a computer system can gain the right to receive Certified Trading Interest information from other parties who are interested in trading with them. This opens the possibility of reversing the arrow of information flow when a trader places an aggressively-priced order in a trading system: the aggressive price is not shown to third parties, but instead helps the trader attract information from third parties with more passive offers.

In addition, users of the inventions referenced above may wish to have the added option of directly exposing the liquidity within their OMS (Order Management System) to other traders using the subject system without submitting any confidential trade information to the subject system's centralized trading server(s). From this point forward said subject system's centralized trading servers are referred to as PTS or Pipeline Trading Server(s). The invention disclosed herein provides traders with that option by creating a decentralized process whereby information about a specified subset of the orders contained in a trader's OMS and/or the orders in the OMS itself are checked for matches with orders resident in the subject system without requiring the trader to submit those orders to the PTS.

### SUMMARY OF THE INVENTION

It is therefore an object of the invention to eliminate a perceived source of information leakage.

It is another object of the invention to allow customers to submit orders into a trading system without sending notifications to undesirable third parties.

To achieve the above and other objects, the present invention is directed to a system and method for allowing traders to control the way in which information about their orders is disseminated to their trades. A first market participant submits an order comprising an indication of a level of visibility which the first market participant wishes to accord to notifications associated with the order. The indication of the level of visibility is independent of identities of second market participants. The notifications associated with the order are displayed on the computer systems of the second market participants only in accordance with the indication of the level of visibility.

A ‘Stealth’ order entry option is provided that can follow “Dark” or “Black” order lighting rules, described herein. The purpose of this new order entry option is to give users of the subject system greater control over the Symbol Activity Indicator (Orange Light in a preferred embodiment, although the specifics of the user interface are illustrative rather than limiting); more specifically it allows them to limit (or eliminate) the frequency with which the Symbol Activity Indicator is displayed in conjunction with the presence of their firm, auto-executable orders in the subject system. The rules associated with the Stealth option may be configured on the Trading Server at the firm/user level. In the preferred embodiment the default rule for the Stealth order will be Dark, but other embodiments can have the default as Black. In a preferred embodiment the Dark and/or Black Stealth order option is only provided to a subset of Buy side customers; however in other embodiments, Stealth orders will be provided for all customers including all Buy side and Sell side users.

When a user enters a firm, auto-execute order in the system as “Dark” the corresponding symbol on the Block Board (the symbol that represents the stock in which the order is placed) will remain white. Furthermore, the symbol will stay white most of the time.

Dark orders do not have standing, meaning they are not given Price-time priority in the subject system's order queue. More specifically, if a non Dark order is resident in the system at the same time as an order in the same symbol on the same side with the same price that is not classified as Dark (or Black), and a contra to the orders arrives in the system; the non Dark order will receive the execution even if it was entered after the Dark order.

Dark orders will generate yellow contra present indications when they are priced below a reference price and a contra order that is priced at or better than the reference price is entered into the system. Also when Dark orders are priced at or above the reference price they will enable users to receive yellow contra present indications when a contra order that is priced below the reference price is entered into the system.

When Dark orders do generate the Symbol Activity Indicator (the orange light in the symbol on the Block Board), the indicator will flash orange for a limited period of time (mimicking IOC orders), with a delay between flashing events from 1 to 40 minutes.

When a user enters a firm, auto-execute order in the system as “Black” that order will never generate a Symbol Activity Indicator (orange light on Block Board).

A Black Order will not generate a yellow contra present indication when it is priced below the reference price and a contra order is entered into the system that is priced at or above the reference price, nor will it allow a user to receive a yellow contra present indication when it is priced at or above the reference price and a contra order is entered into the system that is priced below the reference price.

Black orders do not have standing, meaning they are not given Price-time priority in the order queue. More specifically, if a Black order is resident in the system at the same time as an order in the same symbol on the same side with the same price that is not classified as Black (or Dark), and a contra to the orders arrives in the system; the non Black order will receive the execution even if it was entered after the Black order.

Black order option may be limited to certain authorized users who have permission to access the feature. This permission can be granted based on any number of criteria as will be understood by those skilled in the art, including but not limited to user or firm level trade history or firm classification, i.e. Buy side or Sell Side customer, assets under management.

A trading server can be configured to:

1—Support a new order option, ‘Stealth’

2—Support the configuration of Stealth orders at the Firm level or at the level of an individual User.

3—Allow the ‘Stealth Order Rule’ to be set to either 1—Dark—(order will follow Dark lighting rules) 2—Black—(order will follow Black lighting rules)

4—By default, set the ‘Stealth Order Rule’ to Dark in the preferred embodiment.

5—Support Dark and Black order lighting rules for FIX sessions.

The subject system GUI will include a Symbol Activation Control mechanism in the order entry area of the GUI. In the preferred embodiment, the items available in the Symbol Activation Control mechanism may be driven by the entitlements configured at the server level. For instance, for “Standard” users the control will only permit “Traditional Activation,” while for Premium Users the control will permit “traditional,” “Dark” and “Black.” These user classifications can be set using any number of criteria as can be imagined by those skilled in the art, including but not limited to user or firm level trade history or firm classification, i.e. buy or sell side customer or assets under management.

Other embodiments will allow all users to access all lighting options.

### BRIEF DESCRIPTION OF THE DRAWINGS

A preferred embodiment of the invention will be set forth in detail with reference to the drawings, in which:

FIG. 1 shows a graphical user interface used by a trader;

FIGS. 2A-2C show a menu accessed by the trader through the graphical user interface of FIG. 1;

FIG. 3 shows a flow chart of the preferred embodiment; and

FIG. 4 shows a hardware system on which the preferred embodiment or another embodiment can be implemented.

### DETAILED DESCRIPTION OF THE PREFERRED EMBODIMENTS

A preferred embodiment of the present invention will be set forth in detail with reference to the drawings, in which like reference numerals refer to like elements or steps throughout.

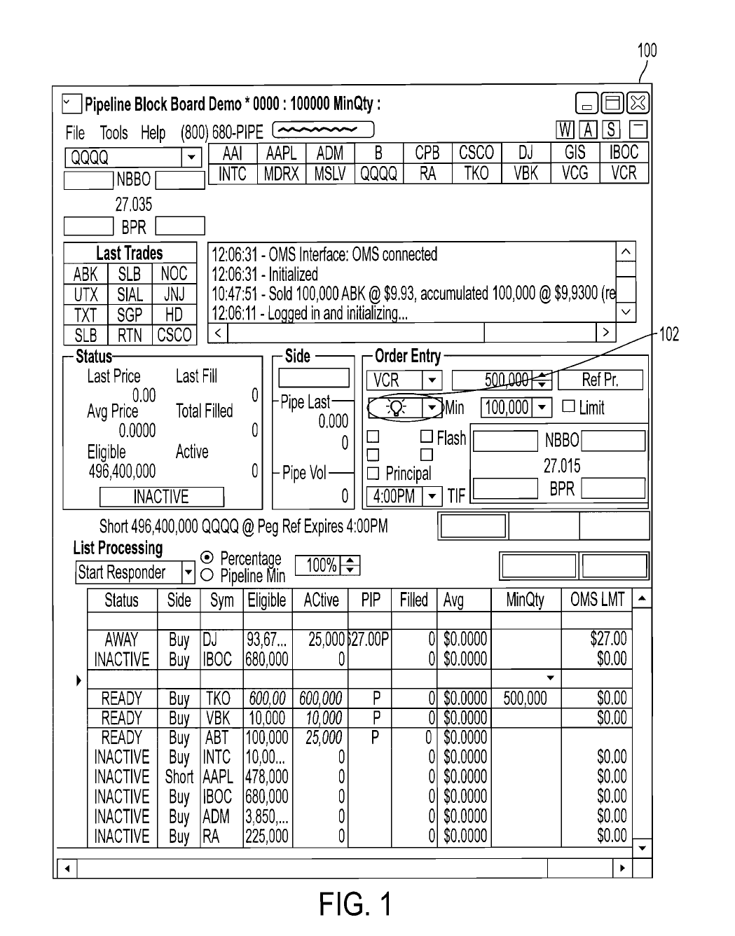

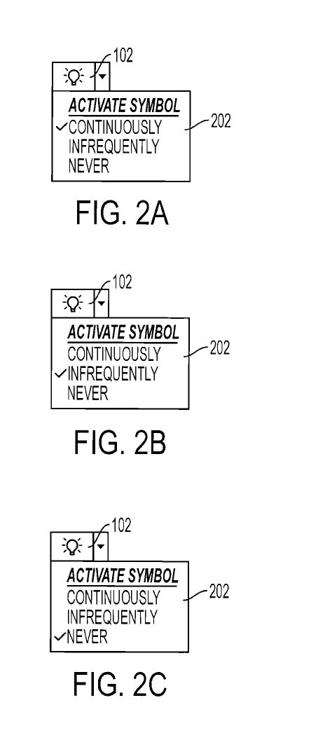

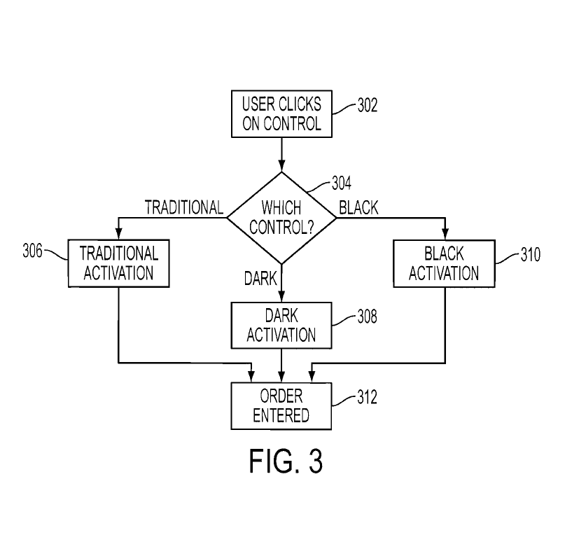

The preferred embodiment implements a feature, called Stealth or Orange Light Control, that allows traders to have some control over the Symbol Activity Indicator (Orange Light). The systems affected are the desktop application and the trading server. Pipeline GUI users will have the symbol activation control 102 shown in FIG. 1 from the Order Entry section of the GUI 100. Clicking on the symbol activation control 102 brings up the menu 202 shown in FIGS. 2A-2C. The operation of the symbol activation control 102 is shown in the flow chart of FIG. 3, which will be explained below.

The items available in the control when the user clicks it will be driven by the entitlements configured at the server level. For instance, “Standard” Pipeline users the control will only permit “Traditional Activation.” Table I below describes the items available when the user clicks on the control (FIG. 3, step 302) in order to choose one of the items (FIG. 3, step 304).

Table I: Items available

TABLE I
Items available

| | |
|---|---|
| FIG. 2A; | Enter order with Traditional Activation |
| FIG. 3, step 306 | The Order will be Orange at Order Entry if priced within the BPR. |
| | The Order will remain Orange when it is priced within the BPR |
| | The Order will become White when its price falls outside the BPR. |
| | This time delay will be randomized between two configurable |
| | bounds, both of which may be infinite. |
| | The order will become white after a reduced delay of 30-60 |
| | seconds following a cancel or complete fill. |
| FIG. 2B; | Enter order Dark |
| FIG. 3, step 308 | The order will be white at Entry and kept white most of the time. |
| | Dark orders do not have standing. |
| | Dark orders send/receive yellow indications. |
| | Dark orders flash orange for a limited period of time (mimicking |
| | IOC orders), with a delay between flashing events from 1 to 40 |
| | minutes. |
| FIG. 2C; | Enter order Black (Never Activated) |
| FIG. 3, step 310 | Never light a symbol orange or yellow. |
| | Never sends/receives a Yellow indication. |
| | Black orders have no standing. |
| | Black order feature will be “hidden” unless the trader has |
| | permission to access the feature. |

Upon the user's selection, the order is entered accordingly in step 312.

Not all Display Options are available to all Order Types, as shown in Table II below.

Table II: Display options

TABLE II
Display options

| | Traditional | Dark | Black |
|---|---|---|---|
| Normal | Default | Option | (Hidden) |
| | | | Option |
| Super Block | X | Default | (Hidden) |
| | | | Option |

Standard users will only have Traditional option available. Premier user will only have Traditional and Dark option: Black option will only be visible and available for the configured users from the Help Desk. User could change the activation option by C/R order from the OE with out affecting the time priority of the order.

An additional optional feature, “Orange Light Re-Flash,” re-flashes the orange light on an already active symbol to indicate a new entry of a reasonably-priced order in the system, or to indicate that a Dark Order would, in the absence of another Traditional Order, cause the orange light to be activated briefly. The systems affected are the trading server and the desktop application.

Depending on the order type submitted, the following re-flash rule will be applied:

Traditional Order: The system will re-flash the symbol immediately

Dark Order: The system will re-flash the symbol within the random time interval selected for that order (between 1-40 minutes). This re-flashing schedule will continue while the order is within the BPR.

Black Order: The system will not re-flash.

In order to prevent firms from being pinged with repetitive flashes from the cycling of orders there will be a server based snooze option. The server-snooze can be set: On/Off and applied at the Firm or Trader level. When the Server Snooze is On, if the Firm triggering the flash is the same firm that previously flashed (or activated) the symbol under the current orange light, the snooze would prevent that recipient from receiving the flash.

Currently, the Pipeline GUI ignores a new activity flag for an already orange symbol. To accommodate this new feature, the Pipeline server will send both an OFF and ON message to re-flash the orange light. The GUI should allow a Symbol Activate (Orange light) message to re-flash the symbol, without the necessity of first sending Symbol Deactivate (White light) message.

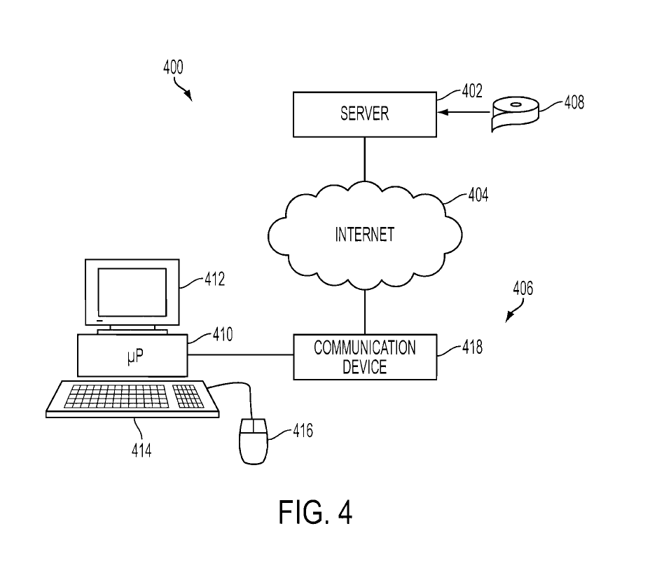

FIG. 4 shows a block diagram of a system 400 on which any of the disclosed embodiments can be implemented. A server 402 communicates over the Internet 404, or another suitable communication medium, with a user's computer (or other device such as an Web-enabled cellular telephone) 406. The software to implement any of the embodiments can be supplied on any suitable computer-readable medium 408. The computer preferably includes a microprocessor 410, a display 412 for displaying the user interface described herein, input devices such as a keyboard 414 and a mouse 416, and a communication device 418, such as a cable modem, for connecting to the Internet 404.

While a preferred embodiment has been set forth above, those skilled in the art who have reviewed the present disclosure will readily appreciate that other embodiments can be realized within the scope of the invention. For example, numerical values are illustrative rather than limiting, as are specific features of the GUI and specific recitations of hardware. Also, embodiments disclosed separately can be combined in any suitable manner, while embodiments disclosed together can be used separately. Moreover, the invention has applicability beyond the trading of securities, including the trading of financial products (stocks, bonds, options, futures, currencies, etc.) and non-financial items. Furthermore, while it is contemplated that the invention can be used with Order Management Systems as now understood, the invention can also be used with any other information management system that tracks and/or manages trading interest and/or order information as would be known to those skilled in the art, for example but not limited to EMS's (electronic management systems) and other such systems that exist now or may be developed later. Accordingly, the term “order management system” should be construed as encompassing all such systems unless otherwise limited. Therefore, the present invention should be construed as limited only by the appended claims.

We claim:

1. A computer-implemented method of managing market information across a network of market data providers, comprising the steps of:
(a) electronically receiving, from a first market participant over a computer network, an order concerning an item, the order comprising an indication of a level of visibility which the first market participant wishes to accord to notifications associated with the order, the indication of the level of visibility being independent of identities of second market participants;
(b) displaying the notifications associated with the order on computer systems of the second market participants only in accordance with the indication of the level of visibility; and
(c) automatically executing the order in a computer system in communication with the computer network when one of the second market participants enters a matching contra order.

2. The method of claim 1, wherein:
step (a) comprises giving the first market participant an option for never displaying any of the notifications associated with the order on the computer systems of the second market participants; and
step (b) comprises not displaying any of the notifications associated with the order on the computer systems of the second market participants when the first market participant chooses the option for the notifications associated with the order never to be displayed.

3. The method of claim 2, wherein, when the first market participant chooses the option for the notifications associated with the order never to be displayed, the first market participant does not receive an indication that the matching contra order is present.

4. The method of claim 1, wherein step (c) comprises intermittently displaying the notifications associated with the order to the second market participants.

5. The method of claim 4, wherein step (a) comprises receiving a selection from the first market participant of a frequency for displaying the notifications associated with the order.

6. The method of claim 1, wherein other orders not submitted in accordance with step (a) take precedence in trading over the order submitted in step (a).

7. A system for managing market information across a network of market data providers, comprising:
a communication device for communicating over a computer network; and
a processor, in communication with the computer network, configured for:
(a) electronically receiving, from a first market participant over the computer network, an order concerning an item, the order comprising an indication of a level of visibility which the first market participant wishes to accord to notifications associated with the order, the indication of the level of visibility being independent of identities of second market participants;
(b) communicating over the computer network with computer systems of the second market participants for displaying the notifications associated with the order on the computer systems of the second market participants only in accordance with the indication of the level of visibility; and
(c) automatically executing the order when one of the second market participants enters a matching contra order.

8. The system of claim 7, wherein the processor is configured for:
giving the first market participant an option for never displaying any of the notifications associated with the order on the computer systems of the second market participants; and
not displaying any of the notifications associated with the order on the computer systems of the second market participants when the first market participant chooses the option for the notifications associated with the order never to be displayed.

9. The system of claim 8, wherein the processor is configured such that, when the first market participant chooses the option for the notifications associated with the order never to be displayed, the first market participant does not receive an indication that the matching contra order is present.

10. The system of claim 7, wherein the processor is configured for intermittently displaying the notifications associated with the order to the second market participants.

11. The system of claim 10, wherein the processor is configured for receiving a selection from the first market participant of a frequency for displaying the notifications associated with the order.

12. The system of claim 7, wherein the processor is configured such that other orders not having the indication take precedence in trading over the order having the indication.

13. An article of manufacture for managing market information across a network of market data providers, comprising:
a computer-readable storage medium; and
code on the computer-readable storage medium, the code, when executed on a processor, controlling the processor for:
(a) electronically receiving, from a first market participant over a computer network, an order concerning an item, the order comprising an indication of a level of visibility which the first market participant wishes to accord to notifications associated with the order, the indication of the level of visibility being independent of identities of second market participants;
(b) displaying the notifications associated with the order on computer systems of the second market participants only in accordance with the indication of the level of visibility; and
(c) automatically executing the order when one of the second market participants enters a matching contra order.
